(19) United States
(12) Patent Application Publication
(10) Pub. No.: US 2007/0001628 A1
(43) Pub. Date: Jan. 4, 2007

(54) Integral detector-lighting apparatus with multiple mounting orientations

(75) Inventors: Ming Yun Chen, Guang Dong Province (CN); Martin Charles Connor, West Yorkshire (GB)

Correspondence Address: WOLF GREENFIELD & SACKS, PC, FEDERAL RESERVE PLAZA, 600 ATLANTIC AVENUE, BOSTON, MA, 02210-2206, US

(73) Assignee: IQ Group SDN BHD, Pulau Pinang (MY)

(21) Appl. No.: 11/448,932

(22) Filed: Jun. 7, 2006

(30) Foreign Application Priority Data
Jun. 30, 2005 (MY) PI 20052993

(51) Int. Cl. H05B 37/02

(52) U.S. Cl. 315/362

(57) ABSTRACT

According to the present invention, a specific example is provided in the shape of a rectangular box constructed with a front cover, a decorative cover, a box, one or multiple light sources and a sensor module. A first connecting point with a docking bay is electrically provided on one pre-determined position of the apparatus, and a second connecting point with a docking bay is electrically provided on another pre-determined position of the apparatus. The sensor module is electrically connected to one connecting point with the docking bay while the other connecting point with the docking bay is closed off by a plug means whence the lighting apparatus is mounted in any one selected mounting orientation. The sensor module is always disposed at the bottom side of the apparatus. The integral detector-lighting apparatus can assume an orthogonal shape such as rectangular or oblong shape, an oval shape, a circular shape or triangular shape. In either orientation, the apparatus is effectively incorporated with air ventilation openings for heat dissipation and aqueduct outlets for water drainage.

### TECHNICAL FIELD

The present invention relates generally to integral motion-activated detector-lighting apparatus. The present invention relates specifically to an integral detector-lighting apparatus that is adapted with multiple mounting orientations.

### BACKGROUND ART

A prior art infrared motion detector device is electrically connected to a rotatable lamp assembly, but its mounting orientation remains substantially unchanged. The motion detector device comprises an arc lens assembly and a pyro-sensor, or microwave sensor or ultrasonic sensor or a combination of sensors, with electrical circuitry is separated from the lamp assembly. Generally, conventional sensor controlled lighting apparatus comes with fixed mounting orientation during installation. The sensor is also permanently attached to the apparatus. Sensor controlled lighting apparatus is mainly used as outdoor lighting fixture to provide ambient light for residential house, apartment walkway, stairs, car porch, garden and such like, whence the sensor detects motion in a comparatively dark environment. The main disadvantage of this prior art is that the lighting apparatus lacks flexibility in adapting to the environment to be monitored during installation.

### SUMMARY OF THE INVENTION

The present invention aims to provide an integral detector-lighting apparatus constructed with a front cover, a decorative cover, a box, one or multiple light sources, a plug means and a sensor module. A first connecting point with a docking bay is electrically provided on one pre-determined position on the box, and a second connecting point with a docking bay is electrically provided on another pre-determined position on the box. The sensor module is selectively connected to either one connecting point with the docking bay while the other connecting point with the docking bay is plugged off and inoperative whereby the sensor module and the operative connecting point with the docking bay are always disposed at the bottom side of the box when mounted in one selected orientation. The invention is adapted for multiple mounting orientations.

### BRIEF DESCRIPTION OF THE DRAWINGS

In order that the invention may be more readily understood and put into practical effect, a preferred example of the invention will now be described with reference to the accompanying drawings, in which:

FIG. 1 shows a perspective view of one specific example of the present invention mounted in portrait orientation.

FIG. 2 shows a perspective view of the specific example as shown in FIG. 1, with its front and decorative covers removed.

FIG. 3 shows a perspective view of the specific example as shown in FIG. 2, with its sensor module and plug means removed.

FIG. 4a shows an enlarged view of a catch or snap-on mechanism which is to engage the sensor module shown in FIG. 2.

FIG. 4b shows the underside view of the sensor module exposing the male connector.

FIG. 5a shows in perspective the front view of the specific example as shown in FIG. 1, with the front and decorative covers removed.

FIG. 5b shows an enlarged view of the upper portion of the specific example as shown in FIG. 5a.

FIG. 5c shows an enlarged view of the lower portion of the specific example as shown in FIG. 5a.

FIG. 6 shows a perspective view of the specific example mounted in landscape orientation, with its front and decorative covers removed.

FIG. 7a shows the back view of the specific example, with the provision of inner and outer aqueduct outlets, and air ventilation openings.

FIG. 7b shows an enlarged view of the air ventilation openings as shown in FIG. 7a.

FIG. 7c shows an enlarged view of the inner and outer aqueduct outlets as shown in FIG. 7a.

FIG. 8a shows a partial view of the specific example mounted in landscape orientation, with the provision of embankments at one vertical side.

FIG. 8b shows an enlarged view of the embankments disposed at its bottom side.

FIG. 9a shows a circuit diagram connecting two connecting points with docking bays and a terminal block inside the invention incorporating a light source.

FIG. 9b shows a circuit diagram connecting two connecting points with docking bays and a terminal block inside the invention incorporating two light sources and one relay.

FIG. 9c shows a circuit diagram connecting two connecting points with docking bays and a terminal block inside the invention incorporating two light sources and two relays.

### DETAILED DESCRIPTION

According to the teaching of the present invention, an integral detector-lighting apparatus can assume an orthogonal shape including rectangular or oblong shape, an oval shape, a circular or even a triangular shape.

In an orthogonal shape including rectangular or oblong shape, there are two substantially long sides and two substantially short sides. At least two connecting points with docking bays can be electrically disposed at the long and short sides. When mounted in portrait orientation, the short sides are disposed horizontally and the long sides vertically. One connecting point with a docking bay is disposed at the bottom short side, engaging a sensor module in operating mode. Another connecting point with a docking bay is disposed at one long side and is plugged off and inoperative. When mounted in landscape orientation, the long sides are disposed horizontally and the short sides vertically. One connecting point with a docking bay is disposed at the bottom long side, engaging a sensor module in operating mode. Another connecting point with a docking bay is disposed at one short side and is plugged off and inoperative.

In an oval shape, there are substantially two long sides and two protruded portions. One connecting point with a docking bay can be disposed at the middle of the bottom long side and another connecting point with a docking bay can be disposed at one protruded portion.

In a triangular shape, there are three substantially pointed portions, each facing a lateral side. A connecting point with a docking bay can be disposed at any one of the substantially pointed portions, and another connecting point with a docking bay is disposed at the opposite lateral side.

In a circular shape, there is no clear differentiation of long and short sides. The mounting orientation depends on other factors such as the design on the decorative cover.

In other words, the present invention is adapted to be mounted in multiple orientations. For the sake of simplicity, two orientations are explained in the following description of a rectangular shape, such as portrait or landscape orientation. The mounting orientations are oriented at least 90 degrees from each other. Connecting points with docking bays are disposed at pre-determined positions of the apparatus, such that they also correspond with the mounting orientations of the apparatus. When the apparatus is mounted in one orientation, a connecting point with a docking bay should always be disposed at the bottom side of the apparatus whence a sensor module is connected in operating mode. When a sensor module is electrically connected to a selected connecting point with a docking bay, the selected connecting point with a docking bay is thus operative. The other unused connecting point is plugged off and become inoperative.

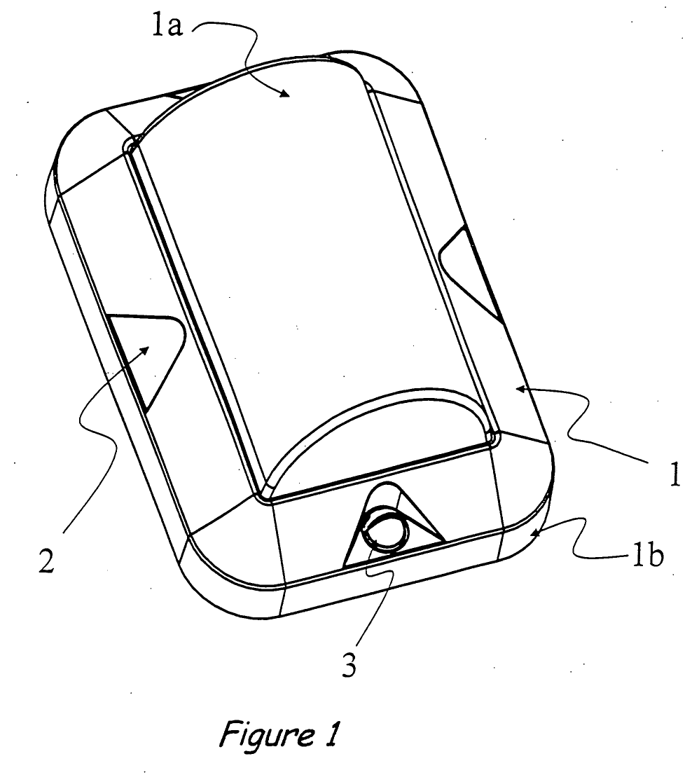

Referring to FIG. 1, one specific example of the present invention assumes a rectangular box shape, and the apparatus is shown in portrait orientation. The specific example carries a light source inside, a sensor module (3) at a bottom side of the box (1b), a front cover (1), and a transparent decorative cover (1a). The design of the rectangular box (1b) is to carry all parts and components of a detector-lighting apparatus inside one integral unit which is sealed from water ingress and facilitates heat dissipation. Openings (2) are provided on the front cover (1), serving as windows to the selected sensor module (3) engaged to the apparatus.

At the central position of one short side of the box (1b), a first connecting point with a docking bay (5) is disposed. At the central position of one long side of the box (1b), a second connecting point with a docking bay (5) is also disposed. In this portrait orientation, the first connecting point with the docking bay (5) is operative and the second connecting point with the docking bay (5) is inoperative. The operative connecting point with the docking bay (5) is electrically connectable to a sensor module (3) of a particular focusing view, and a light source, when in operating mode. When not in operating mode, the connecting point with the docking bay (5) can be closed off with a plug means (4) and is inoperative. This is to avoid electrocution by accident.

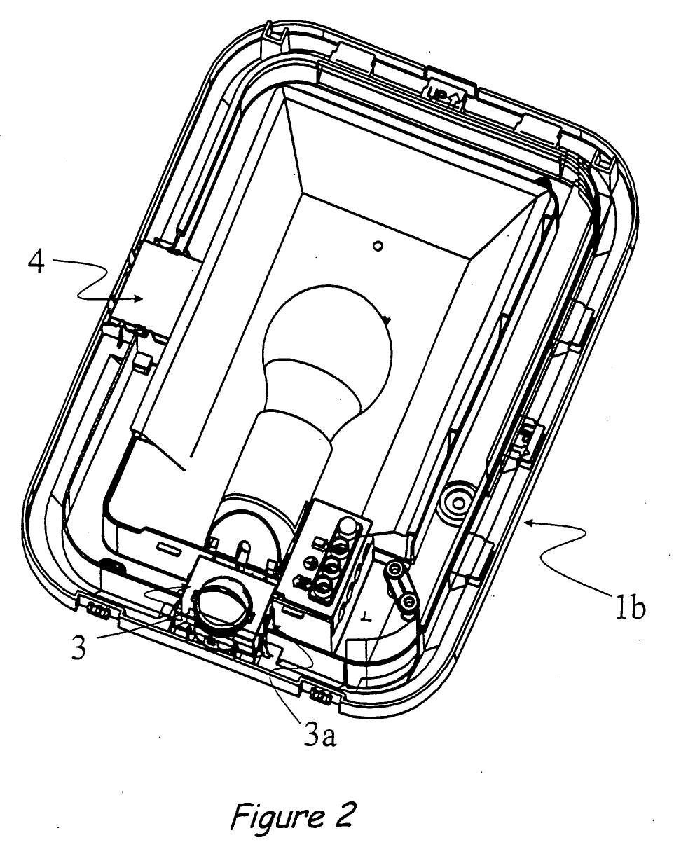

Referring to FIG. 2, the front cover (1) and the decorative cover (1a) have been removed from the specific example. The sensor module (3) is disposed at the first connecting point with the docking bay (5) on the bottom side of the rectangular box (1b). The sensor module (3) is releasably engaged by a catch or snap-on mechanism (3a) and electrically connected to a power supply source shared with a light source. The second connecting point with the docking bay (5) on one long side of the box is closed off by a plug means (4).

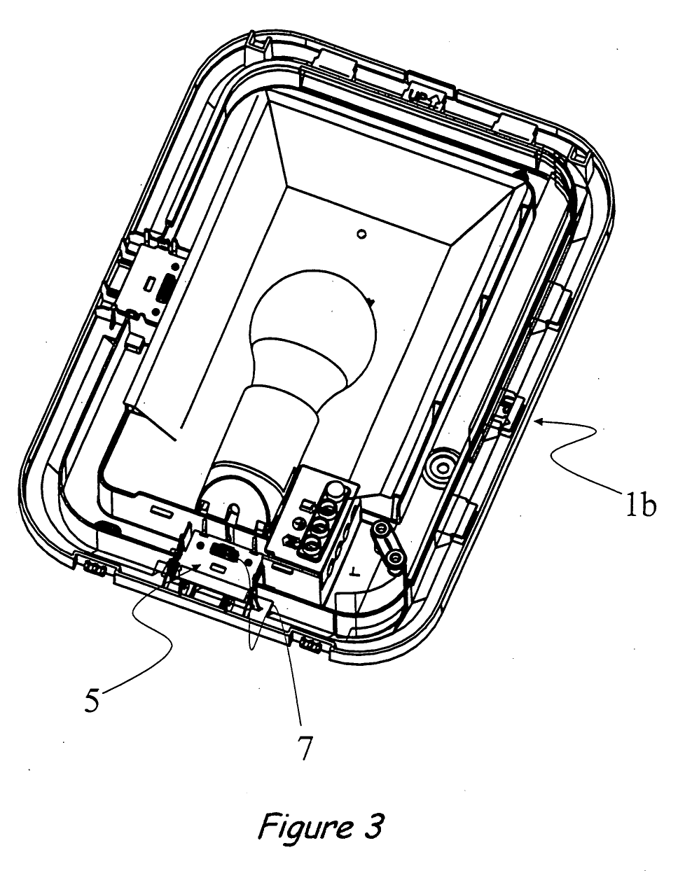

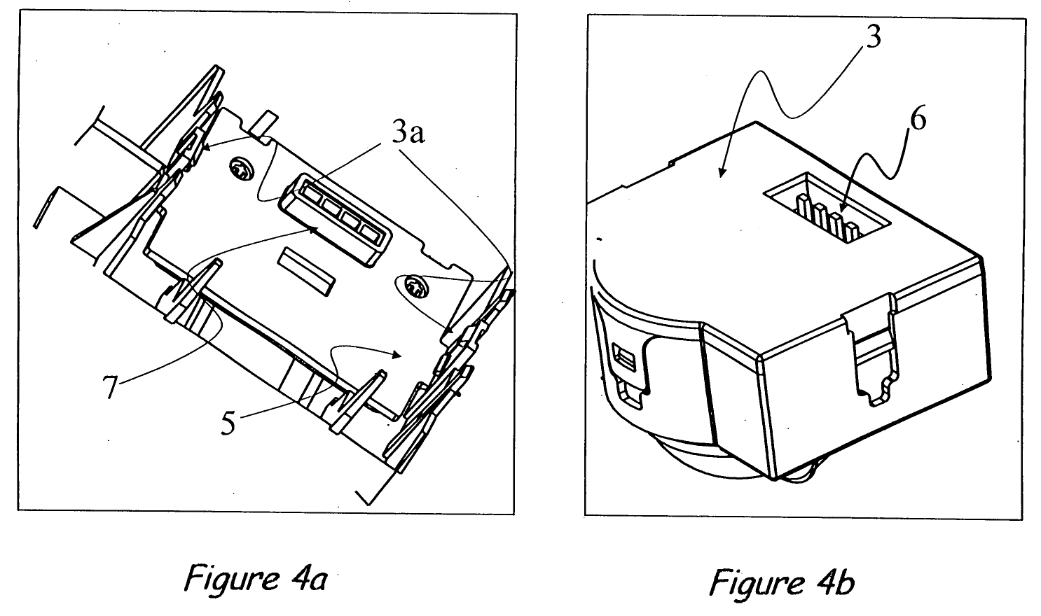

Referring to FIGS. 3, 4a and 4b, a first connecting point with a docking bay (5) is shown, where a standard catch or snap-on mechanism (3a) is to engage the detachable sensor module (3). The sensor module (3) is therefore selectively disposed at the bottom side of the apparatus with the assistance of the catch or snap-on mechanism (3a). The mechanism (3a) allows a sensor module (3) of selectable focusing view to be used. The focusing view includes forward and downward view.

On the connecting point with the docking bay (5), there is provided a female connector (7) and a catch or snap-on mechanism (3a). A male connector (6) is provided on the underside of the sensor module (3), to electrically connect the female connector (7). The catches in the catch or snap-on mechanism (3a) can be released with the assistance of recommended tools to detach the sensor module (3) from the docking bay (5). This will disconnect the electrical circuitry of the light source.

An advantageous feature can further be incorporated into the present invention, where a separate socket for the light source can be supplied at each connecting point with a docking bay. Normally, there is no need to change the position of the light source placed at one connecting point with a docking bay. Additional flexibility is allowed where the light source can be placed at the other connecting point with a docking bay, when the apparatus is mounted in an alternate mounting orientation.

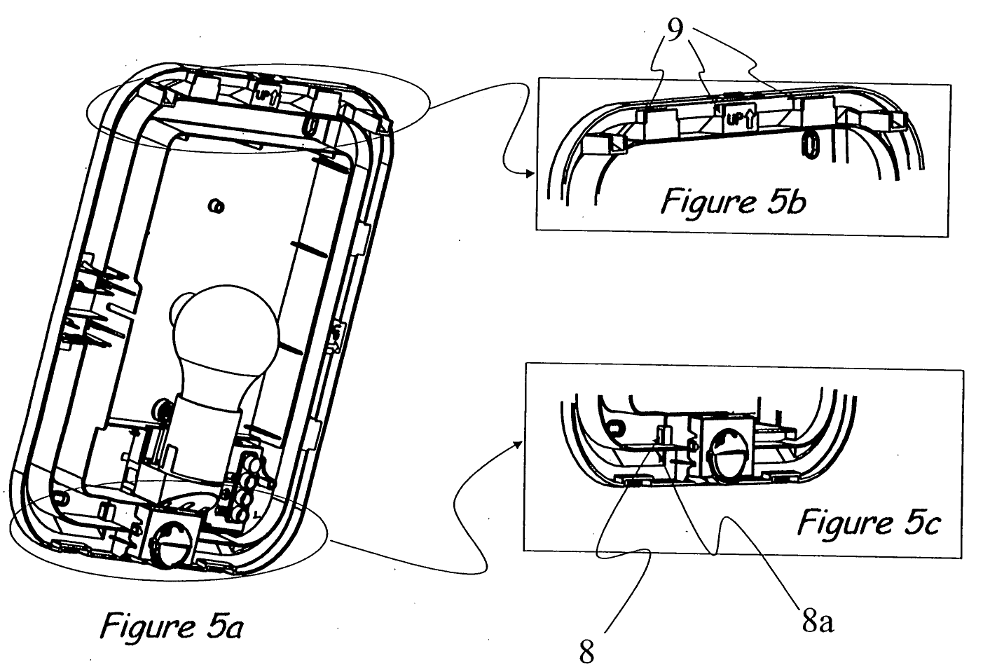

Now referring to FIG. 5a, three air ventilation openings (9) are provided on the upper side of the box (1b), and aqueduct outlets (8, 8a) are provided at the bottom side of the box (1b).

Since the box (1b) carries a light source inside, heat will be generated when the light source is activated. It is also logical to provide heat dissipation mechanism by air circulation. In FIG. 5b, three air ventilation openings (9) are provided on the upper side of the box (1b), as part of its box design.

The invention is primarily used outdoor, exposed to rain. It is therefore logical to provide water drainage mechanism, so that rainwater does not accumulate inside the box (1b). In FIG. 5c, inner and outer aqueduct outlets (8, 8a) are integrally provided at the bottom side of the invention, as part of the box design.

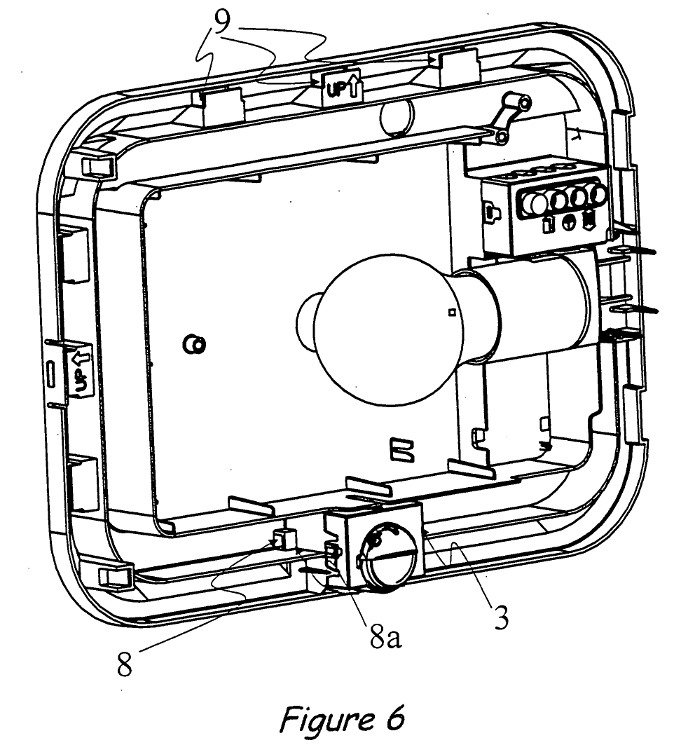

Referring to FIG. 6, the specific example is now mounted in landscape orientation, with its front and decorative covers (1, la) removed. The sensor module (3) is transferred from the first connecting point with a docking bay onto the second connecting point with a docking bay. The first connecting point with a docking bay is then plugged off to avoid electrocution by accident. In this landscape orientation, the second connecting point with a docking bay is operative, and the first connecting point with a-docking bay is plugged off and inoperative.

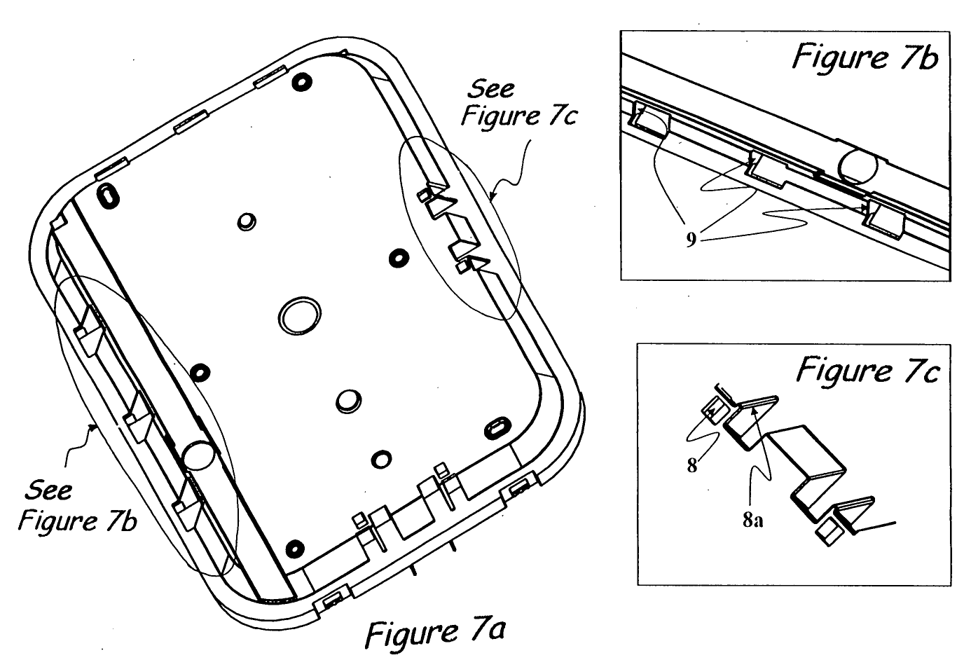

In FIGS. 7a, 7b and 7c, inner and outer aqueduct outlets (8, 8a) are provided at the bottom side of the box (1b). Three air ventilation openings (9) are provided at the upper side of the box (1b).

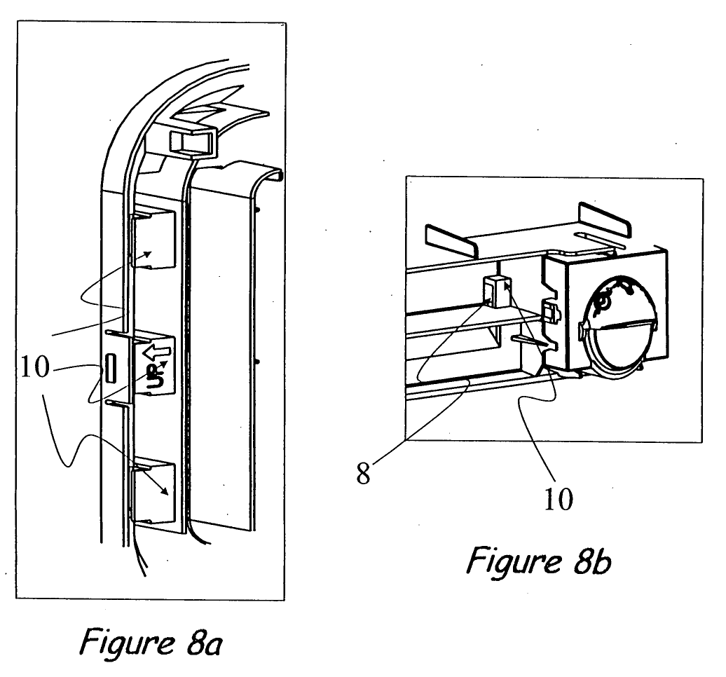

Referring to FIGS. 8a and 8b, embankments (10) are provided along the peripheral of the box (1b). The embankments (10) would reduce the built-up pressure due to water ingress and solid object penetration.

It will be apparent to those skilled in the art that various modifications and variations could be made in the integral detector-lighting apparatus without departing from the scope of the invention.

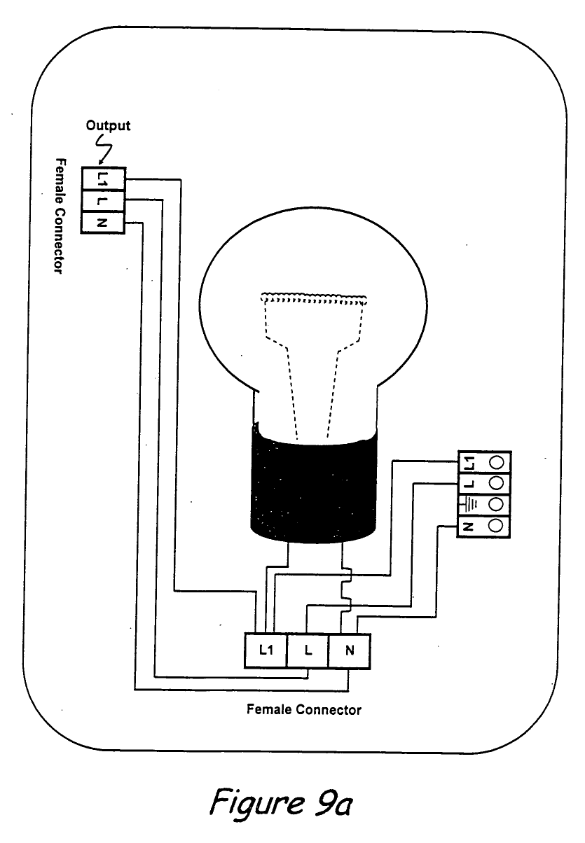

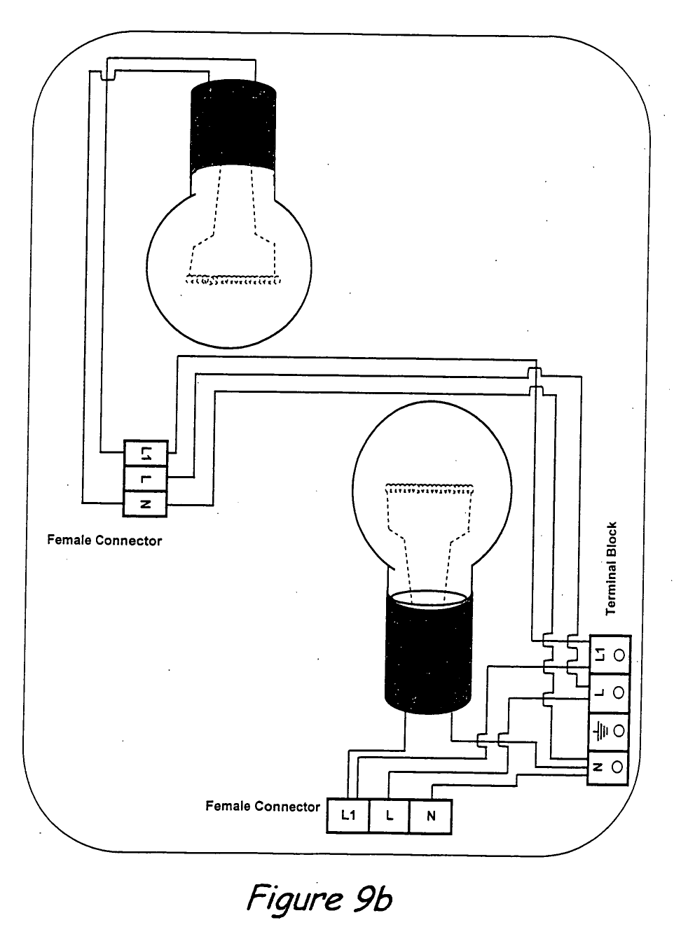

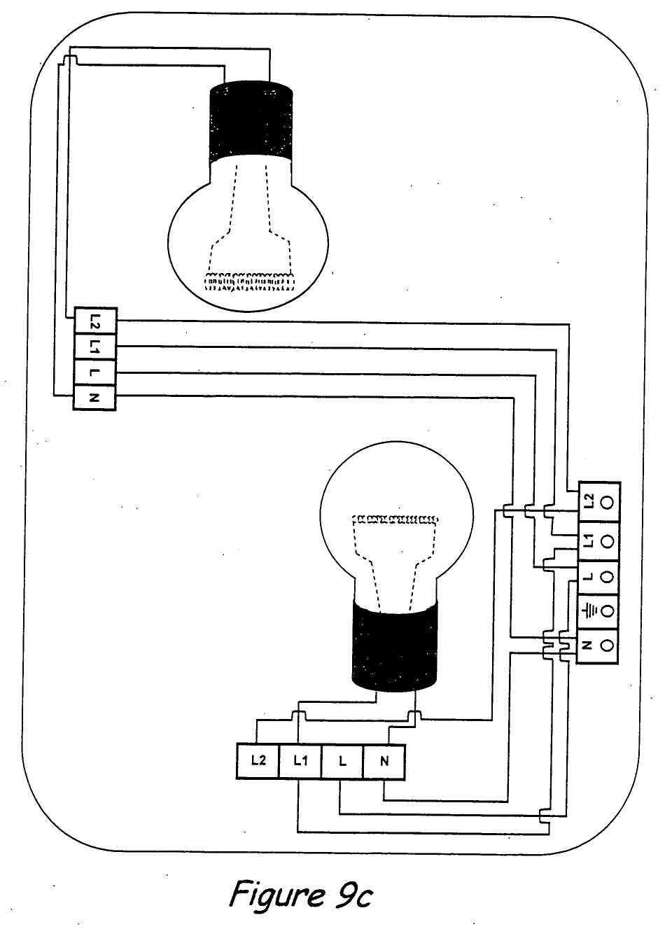

FIGS. 9a, 9b and 9c show circuit diagrams connecting two connecting points each with a docking bay and a terminal block inside the invention incorporating a light source, two light sources and one relay, and two light sources and two relays, respectively. In the one relay design, both light sources are simultaneously switched on and off. In the two relays design, each light source is separately switched on and off.

1. An integral detector-lighting apparatus constructed with a front cover, a decorative cover, a box, a single or multiple light sources and a sensor module, the apparatus comprising:
at least two connecting points with docking bays electrically provided in the apparatus, a first connecting point with a docking bay electrically provided on one pre-determined position on the apparatus, and a second connecting point with a docking bay electrically provided on another pre-determined position on the apparatus;
wherein in one mounting orientation, the sensor module is electrically connected to the first connecting point with the docking bay while the second connecting point with the docking bay is closed off by a plug means;
wherein in another mounting orientation, the sensor module is electrically connected to the second connecting point with the docking bay awhile the first connecting point with the docking bay is closed off by a plug means;
further wherein the apparatus has multiple mounting orientations where the sensor module and the operative connecting point with the docking bay are disposed at the bottom side of the apparatus.

2. An integral detector-lighting apparatus as in claim 1, wherein the multiple mounting orientations include a portrait orientation and a landscape orientation of the apparatus.

3. An integral detector-lighting apparatus as in claim 1, wherein the sensor module is releasably engaged with the assistance of a catch or snap-on mechanism incorporated at the connecting point with the docking bay.

4. An integral detector-lighting apparatus as in claim 3, wherein a sensor module of selectable focusing view can be used for forward and downward view.

5. An integral detector-lighting apparatus as in claim 1, wherein the apparatus has air ventilation openings disposed at its upper side for heat dissipation.

6. An integral detector-lighting apparatus as in claim 1, wherein the apparatus has aqueduct outlets disposed at its bottom side for water drainage.

7. An integral detector-lighting apparatus as in claim 1, wherein the apparatus has a substantially orthogonal shape including a rectangular or oblong shape.

8. An integral detector-lighting apparatus as in claim 1, wherein the apparatus has a substantially oval shape.

9. An integral detector-lighting apparatus as in claim 1, wherein the apparatus has a substantially circular shape.

10. An integral detector-lighting apparatus as in claim 1, wherein the apparatus has a substantially triangular shape.
